(19) United States
(12) Patent Application Publication
(10) Pub. No.: US 2023/0380452 A1
(43) Pub. Date: Nov. 30, 2023

(54) Pet Food Compositions

(71) Applicant: Hill's Pet Nutrition, Inc., Topeka, KS (US)

(72) Inventors: Dayakar BADRI, Lawrence, KS (US); Matthew JACKSON, Topeka, KS (US); Dennis JEWELL, Lawrence, KS (US)

(73) Assignee: Hill's Pet Nutrition, Inc., Topeka, KS (US)

(21) Appl. No.: 18/248,791

(22) PCT Filed: Oct. 12, 2021
(86) PCT No.: PCT/US2021/054460

§ 371 Date: Apr. 12, 2023

Related U.S. Application Data
(60) Provisional application No. 63/091,531, filed on Oct. 14, 2020.

(51) Int. Cl. A23K 20/158; A23K 50/42

(52) U.S. Cl. CPC A23K 20/158; A23K 50/42

(57) ABSTRACT

Described herein are pet food compositions and methods for using them. Such compositions may comprise certain ratios of oleic acid to arachidonic acid. The methods may include feeding the pet an effective amount of the pet food composition.

### CROSS-REFERENCE TO RELATED APPLICATION

This application claims the benefit of priority from U.S. Provisional Application No. 63/091,531, filed Oct. 14, 2020, the contents of which are hereby incorporated herein by reference in their entirety.

### BACKGROUND

The well-being of domestic animals is closely related to their feeding. Correct feeding should result in a fit and healthy pet. To achieve correct feeding, one may utilize certain ingredients and concentrations of those ingredients which yield beneficial effects for the animal. Such beneficial effects may include protection against inflammation, kidney damage, renal insufficiency, cardiovascular disease, and/or high urine solute concentration.

Kidney disease formation is common in dogs as aging occurs. Some veterinarians have recognized an interplay between renal disorders and the cardiovascular system in health and disease resulting in terming the concept cardiovascular-renal disorders (CvRD).

Arachidonic acid (AA) is a major component of cell membrane lipids and could be converted into various metabolites that trigger inflammatory responses. (Wang T. et al., Int J Mol Sci., 2019, 20: 3683). In fact, there is growing evidence of involvement of products of AA metabolism in cardiac fibrosis (Levick S P et al., J Immunol., 2007, 178:641-46). Furthermore, oleic acid concentration within rat serum has been reported to have an inverse relationship with the concentration of arachidonic acid (Hostmark and Haug, Lipids in Health and Disease, 2013, 12:40).

Increased blood plasma levels of interleukin 8 (IL-8) has been shown to potentially be involved with the pathogenesis of acute kidney injury (Liangos et al., Nephron Clin Pract., 2009, 113:c148-C154) and in the establishment and preservation of the inflammatory micro-environment of the insulted vascular wall (Apostolakis S. et al., Cardiovasc Res., 2009, 84(3):353-60).

It would therefore be desirable to provide a pet food composition which may affect one or more of reducing serum levels of arachidonic acid, lowering IL-8 levels, lowering inflammation, and/or protection against cardiovascular-renal disorders.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

Applicants have discovered that utilization of certain ingredients within pet food provides for effective health benefits. In one aspect, the health benefits may be to increase beneficial metabolites of the animal. In another aspect, the health benefits may be to decrease one or more of detrimental metabolites, interleukin, and prostaglandin of the animal. Thus, in one embodiment, the invention is pet food compositions comprising certain ratios of oleic acid to arachidonic acid.

In at least one embodiment, the present invention is directed to a pet food composition comprising: oleic acid (“OA”) and arachidonic acid (“AA”); wherein the ratio of oleic acid to arachidonic acid is about 87.6:1 or greater. In certain embodiments, the ratio of oleic acid to arachidonic acid (“OA:AA”) is from about 140:1 to about 200:1. In certain embodiments, the ratio of OA:AA is about 172:1. In certain embodiments, the oleic acid is present in an amount of about 4% to about 12%, about 4% to about 10%, or about 4% to about 9%, based on the dry weight of the pet food composition. In certain embodiments, the arachidonic acid is present in an amount of about 0.02% to about 1%, about 0.02% to about 0.08%, or about 0.02% to about 0.06%, based on the dry weight of the pet food composition. In certain embodiments, the composition further comprises one or more omega-3 fatty acids. In certain embodiments, the omega-3 fatty acids are present in an amount of about 0.1% to about 1%, about 0.1% to about 0.8%, or about 0.3% to about 0.8%, based on the dry weight of the pet food composition. In certain embodiments, the composition further comprises one or more omega-6 fatty acids. In certain embodiments, the omega-6 fatty acids are present in an amount of about 1% to about 10%, about 1.5% to about 7%, or about 2% to about 5%, based on the dry weight of the pet food composition. In certain embodiments, the ratio of omega-3 fatty acid to omega-6 fatty acid is from about 1:5 to about 1:10, about 1:6 to about 1:9, or about 1:7 to about 1:9.

In further embodiments, the invention is directed to a method for increasing the oleic acid conjugated metabolites and decreasing the arachidonic acid conjugated metabolites in a dog, comprising feeding the animal a pet food composition as described in any one of claims 1 to 10. In certain embodiments, the method comprises feeding the animal a pet food composition as described in any of the previous embodiments. In further embodiments, the method is directed to reducing prostaglandin E2 (PGE2) levels in the kidney tissue of a dog, comprising feeding the animal a pet food composition as described in any one of the previous embodiments.

In further embodiments, the invention is directed to a pet food composition comprising; oleic acid (OA) and arachidonic acid (AA); wherein the ratio of oleic acid to arachidonic acid is about 38.0:1 or greater. In certain embodiments, the ratio of OA:AA is from about 38:1 to about 60:1. In certain embodiments, the ratio of OA:AA is about 43:1. In certain embodiments, the oleic acid is present in an amount of about 2% to about 8%, about 3% to about 7%, or about 4% to about 6%, based on the dry weight of the pet food composition. In certain embodiments, the arachidonic acid is present in an amount of about 0.05% to about 2%, about 0.05% to about 1%, or about 0.07% to about 0.3%, based on the dry weight of the pet food composition. In certain embodiments, the composition further comprises one or more omega-3 fatty acids. In certain embodiments, the omega-3 fatty acids are present in an amount of about 0.05% to about 1%, about to about 0.08%, or about 0.05% to about 0.5%, based on the dry weight of the pet food composition. In certain embodiments, the composition further comprises omega-6 fatty acids. In certain embodiments, the omega-6 fatty acids are present in an amount of about 1% to about 10%, about 1.5% to about 5%, or about 2% to about 5%, based on the dry weight of the pet food composition. In certain embodiments, the ratio of omega-3 fatty acids to omega-6 fatty acids is from about 1:10 to about 1:20, about 1:12 to about 1:18, or about 1:12 to about 1:16. In further embodiments, the invention is a method for increasing the oleic acid conjugated metabolites and decreasing the arachidonic acid conjugated metabolites in a cat, comprising feeding the animal a pet food composition as described in any one of the embodiments within this paragraph. In certain embodiments, the invention is a method for reducing prostaglandin E2 (PGE2) levels in the kidney tissue of a cat, comprising feeding the animal a pet food composition as described in any one of the embodiments within this paragraph.

Further areas of applicability of the present invention will become apparent from the detailed description provided hereinafter. It should be understood that the detailed description and specific examples, while indicating the typical embodiments of the invention, are intended for purposes of illustration only and are not intended to limit the scope of the invention.

### BRIEF DESCRIPTION OF THE DRAWINGS

The detailed description of the invention will be better understood when read in conjunction with the appended drawings. It should be understood, however, that the invention is not limited to the precise arrangements and instrumentalities of the embodiments shown in the drawings.

FIG. 1 depicts a chart showing the comparison of oleic acid (OA); and arachidonic acid (AA) conjugated metabolites collected from dog serum.

FIG. 2 depicts a chart showing the comparison of oleic acid (OA); and arachidonic acid (AA) conjugated metabolites collected from cat serum.

FIG. 3 depicts a model showing the relationship of arachidonic acid to insufficiency and injury and to cardiovascular risk (CV Risk).

FIG. 4 depicts the eicosanoids biosynthesis pathway from arachidonic acid.

FIG. 5 depicts a MANOVA analysis of serum oleic acid and arachidonic acid conjugated metabolites from dogs.

FIG. 6 depicts the abundance of dog serum oleic acid and arachidonic acid conjugated metabolites.

FIG. 7 depicts a MANOVA analysis of serum oleic acid and arachidonic acid conjugated metabolites from cats.

FIG. 8 depicts the abundance of cat serum oleic acid and arachidonic acid conjugated metabolites.

FIG. 9 depicts serum levels of cytokine IL-8 from dogs.

FIG. 10 depicts a hypothetical mechanism showing the relationship between dietary intake of food containing a high ratio of OA:AA to inflammation and related diseases.

### DETAILED DESCRIPTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other applications and methods. It is to be understood that the invention is not limited in its application to the details of any particular embodiment shown. The terminology used herein is for the purpose of description and not to limit the invention, its application, or uses.

As used herein and in the appended claims, the singular forms “a”, “an”, and “the” include plural references unless the context dictates otherwise. The singular form of any class of the ingredients refers not only to one chemical species within that class, but also to a mixture of those chemical species. The terms “a” (or “an”), “one or more” and “at least one” may be used interchangeably herein. The terms “comprising”, “including”, “containing”, and “having” may be used interchangeably. The term “include” should be interpreted as “include, but are not limited to”. The term “including” should be interpreted as “including, but are not limited to”.

As used throughout, ranges are used as shorthand for describing each and every value that is within the range. Any value within the range can be selected as the terminus of the range.

Unless otherwise specified, all percentages and amounts expressed herein and elsewhere in the specification should be understood to refer to percentages by weight of the total composition. Reference to a molecule, or to molecules, being present at a “wt. %” refers to the amount of that molecule, or molecules, present in the composition based on the total weight of the composition.

According to the present application, use of the term “about” in conjunction with a numeral value refers to a value that may be +/−5% of that numeral. As used herein, the term “substantially free” is intended to mean an amount less than about 5.0 weight %, less than 3.0 weight %, 1.0 wt. %; preferably less than about 0.5 wt. %, and more preferably less than about 0.25 wt. % of the composition.

Unless defined otherwise, all technical and scientific terms used herein have the same meanings as commonly understood by one of ordinary skill in the art to which this invention belongs. All patents, patent applications, publications, and other references cited or referred to herein are incorporated by reference in their entireties for all purposes. In the event of a conflict in a definition in the present disclosure and that of a cited reference, the present disclosure controls.

The present disclosure is directed toward pet food compositions and methods of using such pet food compositions for the treatment of domestic pets. In certain embodiments, the pet is a dog. In other embodiments, the pet is a cat.

The present inventors have surprisingly and unexpectedly discovered that providing animals a pet food diet comprising a high ratio of oleic to arachidonic acid provides for enhanced health benefit for the animal. Such enhanced health benefit may be exemplified by numerous aspects. In a first aspect, the enhanced health benefit is a synergistic effect for an increase in biomarkers related to health. By feeding animals compositions as described herein, the inventors have observed a statistically significant linear relationship between an overall average of the sum of changes of certain biomarkers and the ratio of OA:AA utilized. This relationship was observed by taking the sum of oleic acid containing metabolites and comparing it to the sum of arachidonic acid containing metabolites in companion animals fed various food compositions. Without being bound to theory, it is understood that an increasing amount of arachidonic acid containing metabolites produces proinflammatory effects while an increasing amount of oleic acid containing metabolites is less inflammatory.

In one aspect, the present disclosure therefore provides pet food compositions comprising oleic acid and arachidonic acid at certain ratios to each other. In dogs, ratio of oleic acid to arachidonic acid may be about 87.6 or greater. In cats, the ratio of oleic acid to arachidonic acid may be about 38.0 or greater. The weight ratios used herein may be expressed as mass fractions. For example, a weight ratio of oleic acid to arachidonic acid of 38.0:1 may be expressed as the mass fraction of 38. Similarly, a weight ratio of oleic acid to arachidonic acid of 87.6:1 may be expressed as mass fraction of 87.6. In certain embodiments, the pet food is in a dry form. In certain embodiments, the pet food is in a wet form.

The pet food composition comprises oleic acid (“OA”) and arachidonic acid (“AA”) at certain ratios. For instance, in some embodiments for canines, the pet food composition may have a weight ratio of oleic acid to arachidonic acid of from about 87.6:1 to about 200:1, about 87.6:1 to about 180:1, about 87.6:1 to about 160:1, about 87.6:1 to about 150:1, about 87.6:1 to about 140:1, about 87.6:1 to about 130:1, about 87.6:1 to about 120:1, about 87.6:1 to about 110:1, about 87.6:1 to about 100:1; about 100:1 to about 200:1, about 100:1 to about 180:1, about 100:1 to about 160:1, about 100:1 to about 150:1, about 100:1 to about 140:1, about 100:1 to about 130:1, about 100:1 to about 120:1, about 100:1 to about 110:1; about 120:1 to about 200:1, about 120:1 to about 180:1, about 120:1 to about 160:1, about 120:1 to about 150:1, about 120:1 to about 140:1, about 120:1 to about 130:1; about 130:1 to about 200:1, about 130:1 to about 180:1, about 130:1 to about 160:1, about 130:1 to about 150:1, about 130:1 to about 140:1; about 140:1 to about 200:1, about 140:1 to about 180:1, about 140:1 to about 160:1, about 140:1 to about 150:1; about 150:1 to about 200:1, about 150:1 to about 180:1, about 150:1 to about 160:1; about 160:1 to about 200:1, about 160:1 to about 180:1; about 170:1 to about 200:1, about 170:1 to about 180:1; about 180:1 to about 200:1, or about 190:1 to about 200:1, including any ranges or subranges thereof. In some embodiments for felines, the pet food composition may have a weight ratio of oleic acid to arachidonic acid of from about 38:1 to about 150:1, about 38:1 to about 125:1, about 38:1 to about 100:1, about 38:1 to about 80:1, about 38:1 to about 70:1, about 38:1 to about 60:1, about 38:1 to about 50:1; about 50:1 to about 150:1, about 50:1 to about 125:1, about 50:1 to about 100:1, about to about 80:1, about 50:1 to about 70:1, about 50:1 to about 60:1; about 60:1 to about 150:1, about 60:1 to about 125:1, about 60:1 to about 100:1, about 60:1 to about 80:1, about 60:1 to about about 70:1 to about 150:1, about 70:1 to about 125:1, about 70:1 to about 100:1, about 70:1 to about 80:1; about 80:1 to about 150:1, about 80:1 to about 125:1, about 80:1 to about 100:1; about 90:1 to about 150:1, about 90:1 to about 125:1, about 90:1 to about 100:1; about 100:1 to about 150:1, about 100:1 to about 125:1; about 110:1 to about 150:1, about 110:1 to about 125:1; about 120:1 to about 150:1, about 130:1 to about 150:1, or about 140:1 to about 150:1, including any ranges or subranges therebetween.

In certain embodiments, the ratio of OA:AA is from about 140:1 to about 200:1. In other embodiments, the ratio of oleic acid to arachidonic acid (“OA:AA”) is about 172:1. In certain embodiments, the ratio of OA:AA is from about 160:1 to about 200:1, about 160:1 to about 195:1, about 165:1 to about 190:1, or about 170:1 to about 185:1. In further embodiments, the ratio of OA:AA is about 172.2. In other embodiments, the ratio of OA:AA is from about 38:1 to about or about 43:1.

The oleic acid may be present at various amounts or concentrations. In one embodiment, oleic acid may be present in an amount of from about 4% to about 12%, based on the dry weight of the pet food composition. For example, the oleic acid may be present in an amount of about 4.0 weight %, about 4.2 weight %, about 4.6 weight %, about 4.8 weight %, about 5.0 weight %, about weight %, about 5.4 weight %, about 5.6 weight %, about 5.8 weight %, about 6.0 weight %, about 6.2 weight %, about 6.5 weight %, about 6.8 weight %, about 7.0 weight %, about 7.25 weight %, about 7.5 weight %, about 7.75 weight %, about 8.0 weight %, about 8.25 weight %, about 8.5 weight %, about 8.75 weight %, about 9.0 weight %, about 9.5 weight %, about 10.0 weight %, about 10.5 weight %, about 11.0 weight %, about 11.5 weight %, about 12.0 weight %, about 12.5 weight %, about 13.0 weight %, about 13.5 weight %, or about 14.0 weight %. In another example, the oleic acid may be present in an amount of from about 4% to about 10%, about 4% to about 9.5%, or about 4% to about 9%, based on the dry weight of the pet food composition. In further embodiments, the oleic acid is present in an amount of about 2% to about 8%, about 3% to about 7%, or about 4% to about 6%, based on the dry weight of the pet food composition.

The arachidonic acid may be present at various amounts or concentrations. In one embodiment, arachidonic acid may be present in an amount of from about 0.02% to about 1%, based on the dry weight of the pet food composition. For example, the arachidonic acid may be present in an amount of about 0.02 weight %, about 0.04 weight %, about 0.06 weight %, about weight %, about 0.1 weight %, about 0.12 weight %, about 0.14 weight %, about 0.16 weight %, about 0.18 weight %, about 0.2 weight %, about 0.22 weight %, about 0.24 weight %, about weight %, about 0.28 weight %, about 0.3 weight %, about 0.35 weight %, about 0.4 weight %, about 0.45 weight %, about 0.5 weight %, about 0.55 weight %, about 0.6 weight %, about 0.65 weight %, about 0.7 weight %, about 0.75 weight %, about 0.8 weight %, about 0.85 weight %, about 0.9 weight %, about 0.95 weight %, or about 1.0 weight %. In another example, the arachidonic acid may be present in an amount of from about 0.02% to about 0.08%, about 0.02% to about 0.06%, or about 0.02% to about 0.04%, based on the dry weight of the pet food composition. In further embodiments, the arachidonic acid is present in an amount of about 0.05% to about 2%, about 0.05% to about 1%, or about 0.07% to about 0.3%, based on the dry weight of the pet food composition.

In certain embodiments, the pet food further comprises one or more omega-3 fatty acids. The omega-3 fatty acids may be present at various amounts or concentrations. In one embodiment, the omega-3 fatty acids may be present in an amount of from about 0.1% to about 1%, based on the dry weight of the pet food composition. For example, the omega-3 fatty acids may be present in an amount of about 0.1 weight %, about 0.125 weight %, about 0.15 weight %, about 0.175 weight %, about 0.2 weight %, about 0.225 weight %, about 0.25 weight %, about 0.275 weight %, about 0.3 weight %, about 0.325 weight %, about 0.35 weight %, about 0.375 weight %, about weight %, about 0.425 weight %, about 0.45 weight %, about 0.475 weight %, about 0.5 weight %, about 0.525 weight %, about 0.55 weight %, about 0.575 weight %, about 0.6 weight %, about weight %, about 0.7 weight %, about 0.75 weight %, about 0.8 weight %, about 0.85 weight %, about 0.9 weight %, about 0.95 weight %, or about 1.0 weight %. In another example, the omega-3 fatty acid may be present in an amount of from about 0.1% to about 0.8%, or about 0.1% to about 0.6%, based on the dry weight of the pet food composition. In certain embodiments, the omega-3 fatty acids are present in an amount of about 0.05% to about 1%, about 0.05% to about 0.08%, or about 0.05% to about 0.5%, based on the dry weight of the pet food composition.

In certain embodiments, the pet food further comprises one or more omega-6 fatty acids. The omega-6 fatty acids may be present at various amounts or concentrations. In one embodiment, the omega-6 fatty acids may be present in an amount of from about 1% to about 10%, based on the dry weight of the pet food composition. For example, the omega-6 fatty acids may be present in an amount of about 1 weight %, about 1.5 weight %, about 2.0 weight %, about 2.5 weight %, about 3.0 weight %, about 3.5 weight %, about 4.0 weight %, about 4.5 weight %, about 5 weight %, about 5.5 weight %, about 6 weight %, about 6.5 weight %, about 7 weight %, about 7.5 weight %, about 8 weight %, about 8.5 weight %, about 9 weight %, about 9.5 weight %, or about 10 weight %. In another example, the omega-6 fatty acids may be present in an amount of from about 1.5% to about 7%, from about 2% to about 7%, or about 2% to about 5%, based on the dry weight of the pet food composition. In certain embodiments, the omega-6 fatty acids are present in an amount of about 1% to about 10%, about 1.5% to about 5%, or about 2% to about 5%, based on the dry weight of the pet food composition.

In one embodiment, the ratio of omega-3 fatty acid, or acids, to omega-6 fatty acid, or acids, may vary. In certain embodiments, the ratio of omega-3 fatty acid, or acids, to omega-6 fatty acid, or acids, is from about 1:5 to about 1:10, about 1:6 to about 1:9, or about 1:7 to about 1:9. In other embodiments, the ratio of omega-3 fatty acid, or acids, to omega-6 fatty acid, or acids, is about 1:8. In certain embodiments, the ratio of omega-3 fatty acids to omega-6 fatty acids is from about 1:10 to about 1:20, about 1:12 to about 1:18, or about 1:12 to about 1:16.

The pet food compositions may in some embodiments contain one or more additional fatty acid(s). The one or more fatty acid(s) are preferably chosen from those having 10 to 50 total carbon atoms, from 10 to 40 total carbon atoms, or from 10 to 30 total carbon atoms. In some embodiments, the pet food compositions have a total number of carbon atoms of 10 to 30, 12 to 28, 14 to 26, 16 to 24, 16 to 22, or 16 to 20. The one or more fatty acids chosen from polyunsaturated fatty acids. In at least one embodiment, the composition comprises a polyunsaturated fatty acid having a total of 18 carbon atoms.

The fatty acid may be derived from a plant source. Examples of plant sources for deriving or obtaining the fatty acids include, e.g., flaxseed, algae, avocado, hemp seeds, pumpkin seeds, sunflower seeds, walnuts, soya, or combinations of two or more thereof. In some embodiments, however, the fatty acids are derived from an animal source or synthesized.

The additional fatty acid(s) may be comprised of linolenic acid, stearic acid, arachidic acid, oleic acid, stearidonic acid, eicosapentaenoic acid, linolelaidic acid cervonic acid, docosatetraenoic acid, palmitoleic acid, vaccenic acid, paullinic acid, elaidic acid, gondoic acid, erucic acid, nervonic acid, mead acid, or a combination of two or more thereof. In some instances, the additional fatty acid comprises vaccenic acid, oleic acid, elaidic acid, linolelaidic acid, linoleic acid, stearidonic acid, or a combination of two or more thereof. The pet food compositions may comprise a linoleic acid chosen from α-linolenic acid, γ-linolenic acid, and a combination thereof.

The pet food compositions may have an amount of additional fatty acid(s) of from about to about 20 weight %, based on the total weight of the composition. For example, the composition may comprise one or more fatty acid(s) in an amount of about 0.5 to about 20 weight %, about 0.5 to about 15 weight %, about 0.5 to about 10 weight %, about 0.5 to about 8 weight %, about 0.5 to about 6 weight %, about 0.5 to about 5 weight %, about 0.5 to about 4 weight %, about 0.5 to about 3 weight %; about 1 to about 20 weight %, about 1 to about 15 weight %, about 1 to about 10 weight %, about 1 to about 8 weight %, about 1 to about 6 weight %, about 1 to about weight %, about 1 to about 4 weight %, about 1 to about 3 weight %; about 1.5 to about 20 weight %, about 1.5 to about 15 weight %, about 1.5 to about 10 weight %, about 1.5 to about 8 weight %, about 1.5 to about 6 weight %, about 1.5 to about 5 weight %, about 1.5 to about 4 weight %, about 1.5 to about 3 weight %; about 2 to about 20 weight %, about 2 to about 15 weight %, about 2 to about 10 weight %, about 2 to about 8 weight %, about 2 to about 6 weight %, about 2 to about 5 weight %, about 2 to about 4 weight %, about 2 to about 3 weight %; about 2.5 to about 20 weight %, about 2.5 to about 15 weight %, about 2.5 to about 10 weight %, about 2.5 to about 8 weight %, about 2.5 to about 6 weight %, about 2.5 to about 5 weight %, about 2.5 to about 4 weight %; about 3 to about 20 weight %, about 3 to about 15 weight %, about 3 to about 10 weight %, about 3 to about 8 weight %, about 3 to about 6 weight %, about 3 to about 5 weight %, or about 3 to about 4 weight %, including all ranges and subranges thereof, based on the dry weight of the composition.

The compositions of the present invention may optionally comprise additional ingredients suitable for use in pet food compositions. Examples of such ingredients include, but are not limited to, protein, fat, carbohydrates, dietary fibers, amino acids, minerals, trace elements, vitamins, additives.

Dietary fiber refers to components of a plant which are resistant to digestion by an animal's digestive enzymes. Dietary fiber includes soluble and insoluble fibers. Soluble fibers are resistant to digestion and absorption in the small intestine and undergo complete or partial fermentation in the large intestine, e.g., beet pulp, guar gum, chicory root, psyllium, pectin, blueberry, cranberry, squash, apples, oats, beans, citrus, barley, or peas. Insoluble fibers can be supplied by any of a variety of sources, including, for example, cellulose, whole wheat products, wheat oat, corn bran, flax seed, grapes, celery, green beans, cauliflower, potato skins, fruit skins, vegetable skins, peanut hulls, and soy fiber. Crude fiber includes indigestible components contained in cell walls and cell contents of plants such as grains, for example, hulls of grains such as rice, corn, and beans. Typical fiber amounts in compositions of the present disclosure can be from about 0 to 10%, or about 1% to about 5%.

The total dietary fiber may be present at various amounts or concentrations. In one embodiment, total dietary fiber may be present in an amount of less than 20%, based on the dry weight of the pet food composition. In certain embodiments, the total dietary fiber is present in an amount of about 1% to about 20%, based on the dry weight of the pet food composition. For example, total dietary fiber may be present in an amount of about 1 weight %, about 1.5 weight %, about 2.0 weight %, about 2.5 weight %, about 3.0 weight %, about 3.5 weight %, about 4.0 weight %, about 4.5 weight %, about 5.0 weight %, about 5.5 weight %, about 6.0 weight %, about 6.5 weight %, about 7.0 weight %, or any range therebetween. In another example, total dietary fiber may be present in an amount of from about 1 to about 10 weight %, about 2 to about 8 weight %, about 3 to about 8 weight %, about 4 to about 7 weight %, about 4 to about 6 weight %, or about 5 to about 6 weight percent %, including any ranges or subranges thereof, based on the dry weight of the pet food composition.

Amino acids, including essential amino acids, can be added to the compositions of the present disclosure as free amino acids, or supplied by any number of sources, e.g., crude protein, to the compositions of the present disclosure. Essential amino acids are amino acids that cannot be synthesized de novo, or in sufficient quantities by an organism and thus must be supplied in the diet. Essential amino acids vary from species to species, depending upon the organism's metabolism. For example, it is generally understood that the essential amino acids for dogs and cats (and humans) are phenylalanine, leucine, methionine, lysine, isoleucine, valine, threonine, tryptophan, histidine and arginine. In addition, taurine, while technically not an amino acid but a derivative of cysteine, is an essential nutrient for cats.

The composition may include protein at various amounts or concentrations. In one embodiment, the protein may be present in an amount of from about 20% to about 45%, based on the dry weight of the pet food composition. For example, the protein may be present in an amount of about 20 weight %, about 25 weight %, about 30 weight %, about 35 weight %, about 40 weight %, or about 45 weight. In another example, the protein may be present in an amount of from about 25% to about 40%, from about 30% to about 40%, or about 30% to about 35%, based on the dry weight of the pet food composition. In certain embodiments, the protein is present in an amount of about 20% to about 35%, about 25% to about 35%, or about 28% to about 35%, based on the dry weight of the pet food composition.

The pet food composition may comprise protein and/or a digestible crude protein. “Digestible crude protein” is the portion of protein that is available or can be converted into free nitrogen (amino acids) after digesting with gastric enzymes. In vitro measurement of digestible crude protein may be accomplished by using gastric enzymes such as pepsin and digesting a sample and measuring the free amino acid after digestion. In vivo measurement of digestible crude protein may be accomplished by measuring the protein levels in a feed/food sample and feeding the sample to an animal and measuring the amount of nitrogen collected in the animal's feces.

A portion of the protein in the composition may be digestible protein. For example, the composition may include an amount of protein, where about 40 weight % or more, about 50 weight % or more, about 60 weight % or more, about 70 weight % or more, about 80 weight % or more, or about 90 weight % or more of the protein is digestible protein. In some embodiments, e.g., when the composition desirable promotes weight loss, the portion of protein that is digestible protein is about 60 weight % or less, about 50 weight % or less, about 40 weight % or less, about weight % or less, about 20 weight % or less, or about 10 weight % or less, based on the total amount of protein in the composition. In further embodiment, the amount of protein that is digestible protein is about 10 to about 90 weight %, about 10 to about 70 weight %, about 10 to about 50 weight %, about 10 to about 30 weight %; about 20 to about 90 weight %, about 20 to about 70 weight %, about 20 to about 50 weight %, about 20 to about 40 weight %, about 20 to about 30 weight %, about 20 to about 25 weight %; about 23 to about 90 weight %, about 23 to about 70 weight %, about 23 to about 50 weight %, about 23 to about 40 weight %, about 23 to about 30 weight %, about 23 to about 25 weight %, including ranges and subranges therein, based on the total amount of protein in the composition.

The compositions of the present invention may optionally comprise fat. The term “fat” generally refers to a lipid or mixture of lipids that may generally be a solid or a liquid at ordinary room temperatures (e.g., 25° C.) and pressures (e.g., 1 atm). In some instances, the fat may be a viscous liquid or an amorphous solid at standard room temperature and pressure. Fat can be supplied by any of a variety of sources known by those skilled in the art, including meat, meat by-products, canola oil, fish oil, and plants. Plant fat sources include wheat, flaxseed, rye, barley, rice, sorghum, corn, oats, millet, wheat germ, corn germ, soybeans, peanuts, and cottonseed, as well as oils derived from these and other plant fat sources. The compositions of the present disclosure may contain at least about 9% (or from about 9% to about 35%, or from about 10% to about 25%, or from about 15% to about 22%) total fat.

In some cases, the fat in the pet food compositions is crude fat. Crude fat may be included into the pet food compositions in amounts of from about 10 to about 20 weight %, about 10 to about 18 weight %, about 10 to about 16 weight %; about 12 to about 20 weight %, about 12 to about 18 weight %, about 12 to about 16 weight %, about 12 to about 14 weight %, or about 12 to about 13 weight %, based on the total weight of the composition. In some cases, it may be preferable that about 50 weight % or more, about 60 weight % or more, about 70 weight % or more, about 80 weight % or more, or about 90 weight % or more of the total fat is obtained from an animal source. Alternatively, about 50 weight % or more, about 60 weight % or more, about 70 weight % or more, about 80 weight % or more, or about 90 weight % or more of the total fat may be obtained from a plant source.

Carbohydrates can be supplied by any of a variety of sources known by those skilled in the art, including oat fiber, cellulose, peanut hulls, beet pulp, parboiled rice, corn starch, corn gluten meal, and any combination of those sources. Grains supplying carbohydrates can include, but are not limited to, wheat, corn, barley, and rice. Carbohydrates content of foods can be determined by any number of methods known by those of skill in the art. Generally, carbohydrate percentage can be calculated as nitrogen free extract (“NFE”), which can be calculated as follows: NFE=100%-moisture %-protein %-fat %-ash %-crude fiber %. The amount of carbohydrate, e.g., calculated as NFE, present in the composition may be about 10 to about 90 weight %, about 10 to about 70 weight %, about 10 to about 50 weight %, about 10 to about 40 weight %, about 10 to about 30 weight %, about 10 to about 20 wt. %; about 20 to about 90 weight %, about 20 to about 70 weight %, about 20 to about 50 weight %, about 20 to about 40 weight %; about 30 to about 90 weight %, about 30 to about 70 weight %, about 30 to about 50 weight %, about 30 to about 40 weight %; about 40 to about 90 weight %, about 40 to about 70 weight %, or about 40 to about 60 weight %, based on the total weight of the composition.

The compositions of the present disclosure can also contain one or more minerals and/or trace elements, e.g., calcium, phosphorus, sodium, potassium, magnesium, manganese, copper, zinc, chromium, molybdenum, selenium, or iron salts having counterions such as, for example chloride, iodide, fluoride, sulfide or oxide, in amounts required to avoid deficiency and maintain health. These amounts are known by those of skill in the art, for example, as provided in the Official Publication of the Associate of American Feed Control Officials, Inc. (“AAFCO”), Nutrient Requirements of Dogs and Cats, 2006. Typical mineral amounts are about 0.1% to about 4% or about 1% to about 2%.

The compositions of the present invention can also include vitamins in amounts required to avoid deficiency and maintain health. These amounts and methods of measurement are known by those skilled in the art. For example, the Official Publication of the Associate of American Feed Control Officials, Inc. (“AAFCO”), Nutrient Requirements of Dogs and Cats, 2006 provides recommended amounts of such ingredients for dogs and cats. As contemplated herein, vitamins can include, but are not limited to, vitamin A, vitamin B.sub.1, vitamin B.sub.2, vitamin B.sub.6, vitamin B.sub.12, vitamin C, vitamin D, vitamin E, vitamin H (biotin), vitamin K, folic acid, choline, inositol, niacin, and pantothenic acid. Typical vitamin amounts in the composition of the invention are about from 0 to about 3% or about 1% to about 2%.

The compositions of the present disclosure can additionally comprise other additives such as palatability enhancers and stabilizers in amounts and combinations familiar to one of skill in the art. Stabilizing substances include, for example, substances that tend to increase the shelf life of the composition. Other examples of other such additives potentially suitable for inclusion in the compositions of the invention include, for example, preservatives, colorants, antioxidants, flavorants, synergists and sequestrants, packaging gases, stabilizers, emulsifiers, thickeners, gelling agents, and humectants. Examples of emulsifiers and/or thickening agents include, for example, gelatin, cellulose ethers, starch, starch esters, starch ethers, and modified starches. The concentration of such additives in the composition typically can be up to about 5% by weight. In some embodiments, the concentration of such additives (particularly where such additives are primarily nutritional balancing agents, such as vitamins and minerals) is from about 0% to about 2.0% by weight. In some embodiments, the concentration of such additives (again, particularly where such additives are primarily nutritional balancing agents) is from about 0% to about 1.0% by weight.

Foods of any consistency or moisture content are contemplated, e.g., the compositions of the present invention can be, for example, a dry, moist or semi-moist animal food composition. In some embodiments, the moisture content is from about 3% to about 90% of the total weight of the composition. “Semi-moist” refers to a food composition containing from about 25 to about 35% moisture. “Moist” food refers to a food composition that has a moisture content of about 60 to 90% or greater. “Dry” food refers to a food composition with about 3 to about 11% moisture content and is often manufactured in the form of small bits or kibbles.

In certain aspects, the present application further discloses a method of making any of the compositions of the present disclosure. In preparing a composition of the present invention in wet or canned form, any ingredient (e.g., desired ratio of OA:AA) generally can, for example, be incorporated into the composition during the processing of the formulation, such as during and/or after mixing of other components of the composition. Distribution of these components into the composition can be accomplished by conventional means. In some embodiments, ground animal and poultry proteinaceous tissues are mixed with the other ingredients, including fish oils, cereal grains, other nutritionally balancing ingredients, special-purpose additives (e.g., vitamin and mineral mixtures, inorganic salts, cellulose and beet pulp, bulking agents, and the like); and water that is sufficient for processing is also added. These ingredients can be mixed in a vessel suitable for heating while blending the components. Heating of the mixture can be effected using any suitable manner, such as, for example, by direct steam injection or by using a vessel fitted with a heat exchanger. Following the addition of the last ingredient, the mixture can be heated to a temperature range of from about 50° F. (10° C.) to about 212° F. (100° C.). In some instances, the mixture can be heated to a temperature range of from about 70° F. (21° C.) to about 140° F. (60° C.). Temperatures outside these ranges are generally acceptable but may be commercially impractical without use of other processing aids. When heated to the appropriate temperature, the material will typically be in the form of a thick liquid. The thick liquid can be filled into cans. When filled into cans, a lid is applied, and the container is hermetically sealed. The sealed can is then placed into conventional equipment designed to sterilize the contents. This is usually accomplished by heating to temperatures of greater than about 230° F. (110° C.) for an appropriate time, which is dependent on, for example, the temperature used and the composition.

Pet food compositions can alternatively be prepared in a dry form using conventional processes. Typically, dry ingredients, including, for example, animal protein, plant protein, grains, etc., are ground and mixed together. Moist or liquid ingredients, including fats, oils, animal protein, water, etc., are then added to and mixed with the dry mix. The mixture is then processed into kibbles or similar dry pieces. Kibble is often formed using an extrusion process in which the mixture of dry and wet ingredients is subjected to mechanical work at a high pressure and temperature, then forced through small openings and cut off into kibble by a rotating knife. The wet kibble is then dried and optionally coated with one or more topical coatings which may include, for example, flavors, fats, oils, powders, and the like. Kibble also can be made from the dough using a baking process, rather than extrusion, wherein the dough is placed into a mold before dry-heat processing.

In another aspect, the present disclosure provides a method for increasing certain metabolites of a canine or feline, comprising feeding the animal a pet food composition as described herein in an amount effective to increase the beneficial metabolite biomarkers of the animal. In a preferred embodiment, such increase in the beneficial metabolite biomarkers is more than would occur under conditions where one or more of the specified ingredients are not present, or are not present at desired ratios. In a preferred embodiment, the beneficial metabolite biomarkers are oleic acid conjugated metabolites.

In certain embodiments, the present disclosure provides a method for decreasing certain metabolites of a canine or feline, comprising feeding the animal a pet food composition as described herein in an amount effective to decrease the metabolite biomarkers of the animal. In a preferred embodiment, such decrease in the metabolite biomarkers is more than would occur under conditions where one or more of the specified ingredients are not present, or are not present at desired ratios. In a preferred embodiment, the metabolite biomarkers are arachidonic acid conjugated metabolites.

In certain embodiments, the present disclosure provides a method for decreasing certain cytokines of an animal, comprising feeding the animal a pet food composition as described herein in an amount effective to decrease the cytokine of the animal. In a preferred embodiment, such decrease in the cytokine is more than would occur under conditions where one or more of the specified ingredients are not present, or are not present at desired ratios. In a preferred embodiment, the cytokine is interleukin-8 (IL-8).

In certain embodiments, the present disclosure provides a method for decreasing certain prostaglandins of an animal, comprising feeding the animal a pet food composition as described herein in an amount effective to decrease the cytokine of the animal. In a preferred embodiment, such decrease in the prostaglandin is more than would occur under conditions where one or more of the specified ingredients are not present, or are not present at desired ratios. In a preferred embodiment, the prostaglandin is prostaglandin E2 (PGE2).

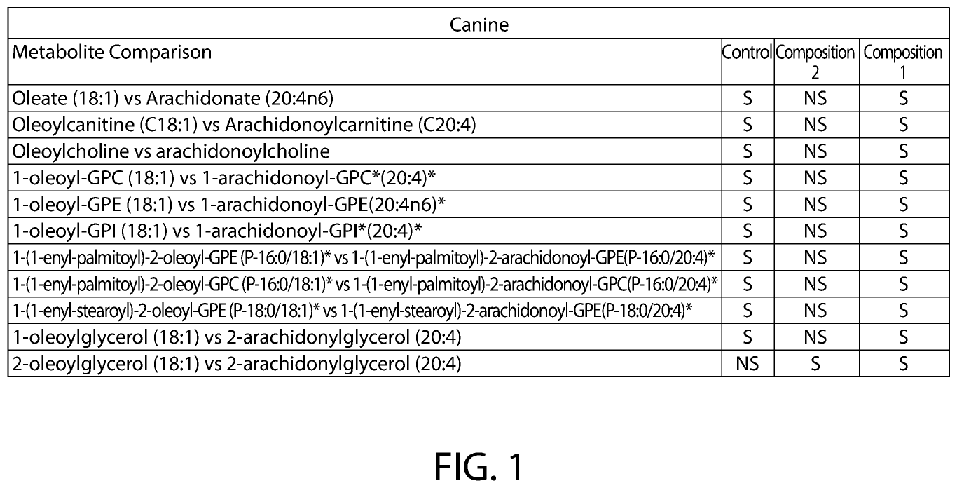

FIG. 1 shows a comparison of various metabolites collected from the serum of dogs. “S” indicates a significance (P<0.05) while “NS” indicates non-significance between the diet's comparison, as determined by matched pairs t-test.

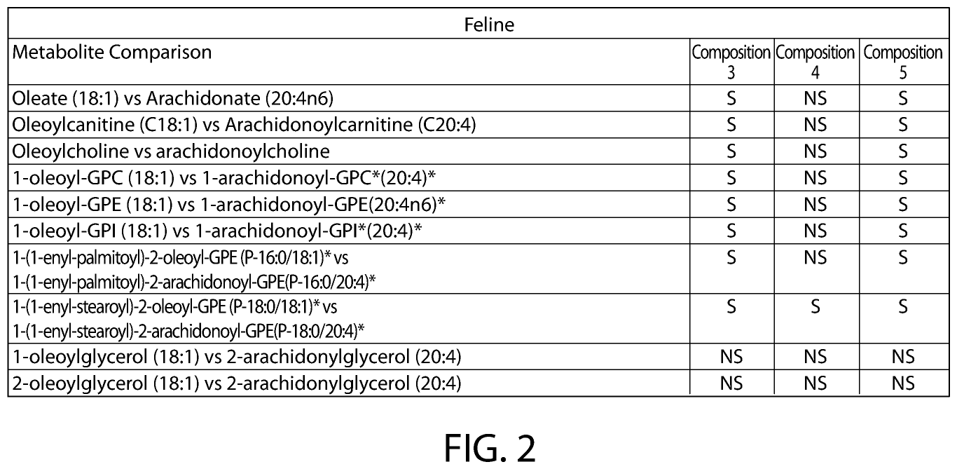

FIG. 2 shows a comparison of various metabolites collected from the serum of dogs. “S” indicates a significance (P<0.05) while “NS” indicates non-significance between the diet's comparison, as determined by matched pairs t-test.

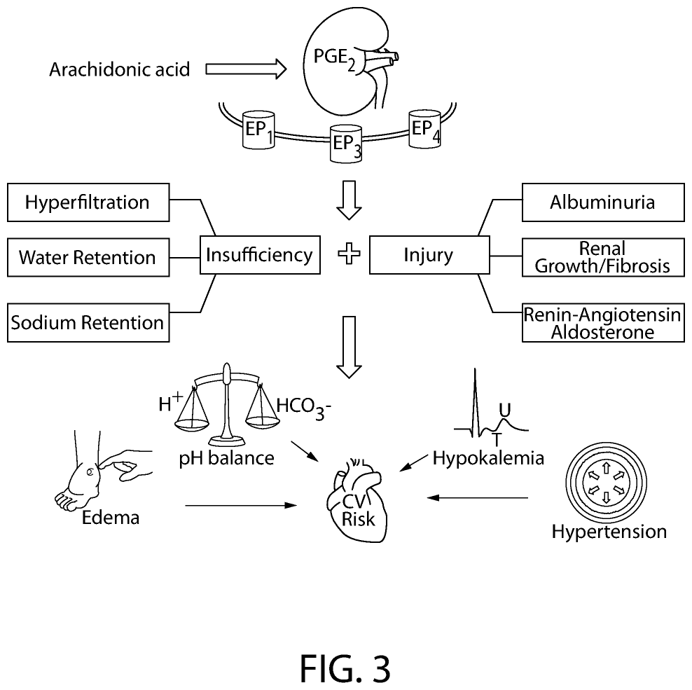

FIG. 3 depicts a model showing the relationship of arachidonic acid to insufficiency and injury and to cardiovascular risk (CV Risk).

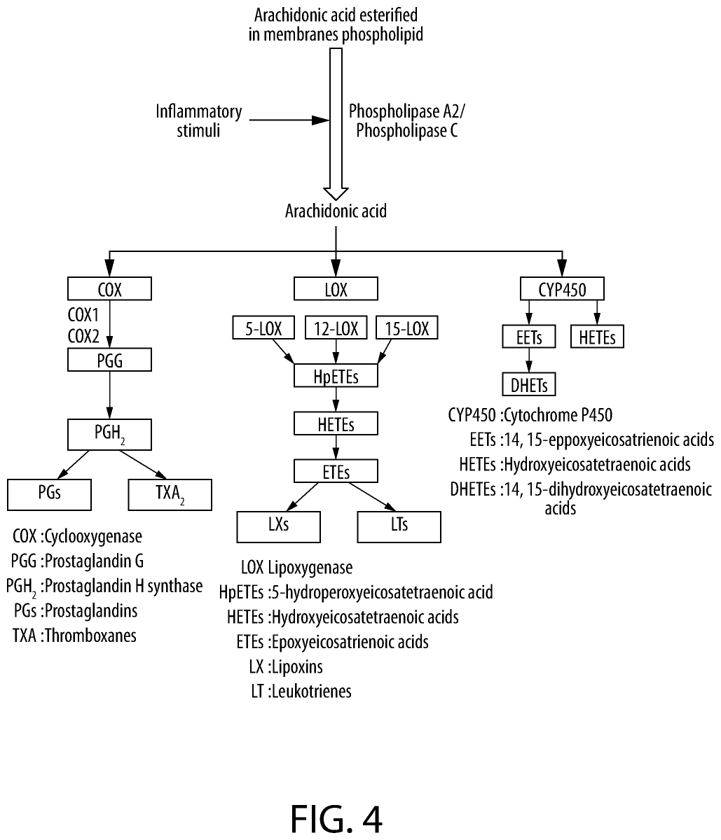

FIG. 4 shows the eicosanoids biosynthesis pathways from arachidonic acid.

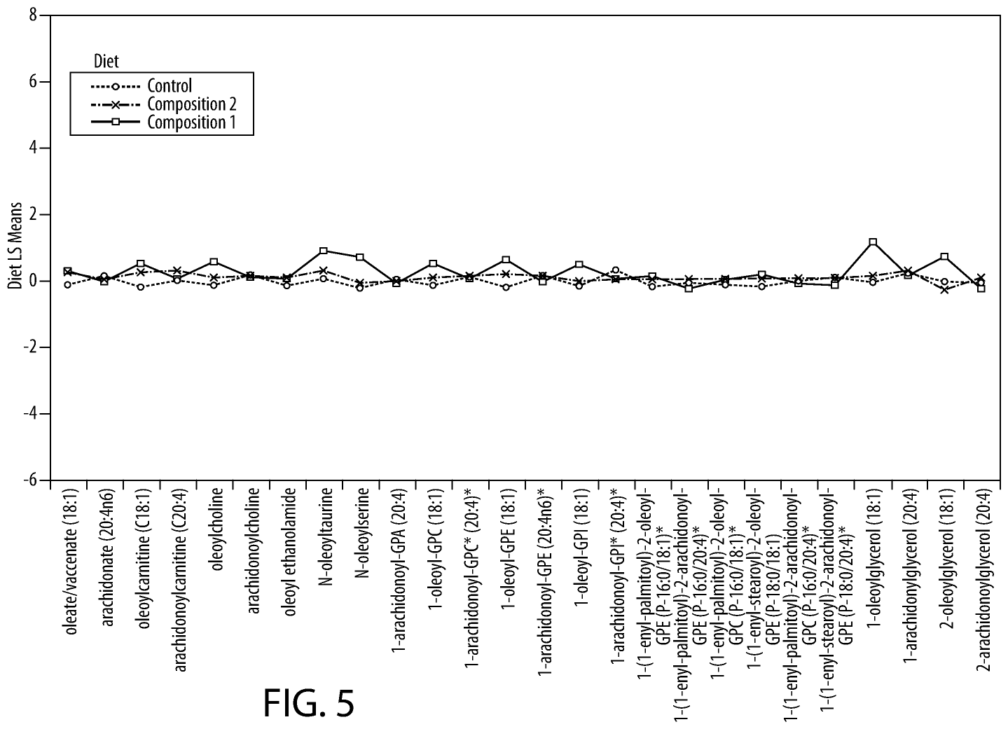

FIG. 5 depicts a MANOVA analysis from dog serum of oleic acid and arachidonic acid conjugated fatty acids.

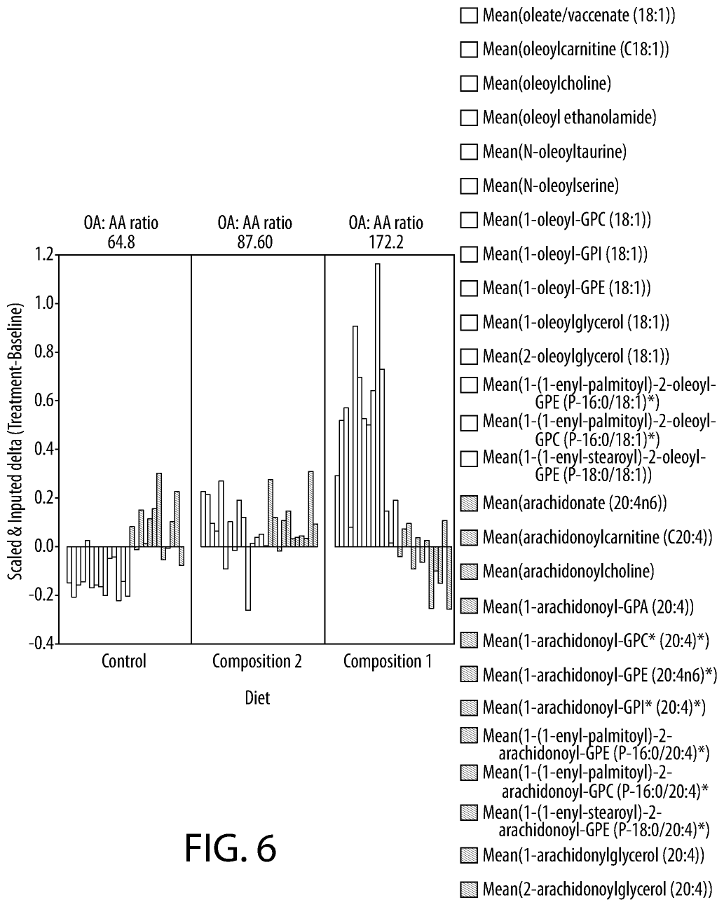

FIG. 6 depicts the abundance of dog serum oleic acid and arachidonic acid conjugated metabolites. These values were determined by creating a variable which was the sum of the mean values for specific metabolites (as listed in FIG. 6) at specific time points.

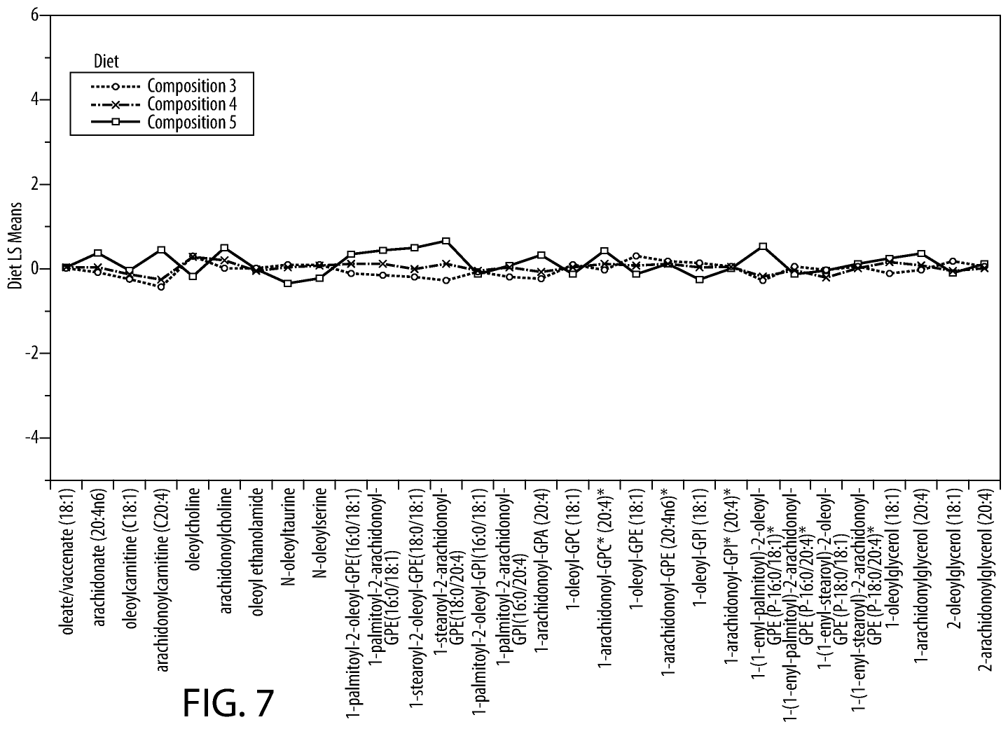

FIG. 7 depicts a MANOVA analysis from cat serum of oleic acid and arachidonic acid conjugated fatty acids.

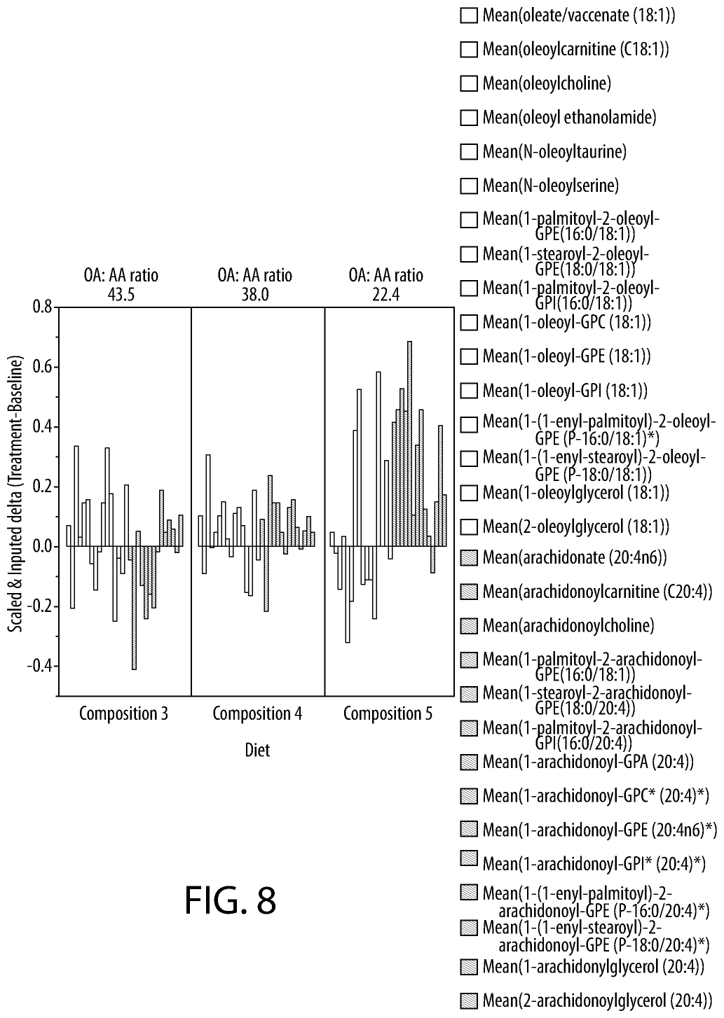

FIG. 8 depicts the abundance of cat serum oleic acid and arachidonic acid conjugated metabolites. These values were determined by creating a variable which was the sum of the mean values for specific metabolites (as listed in FIG. 8) at specific time points.

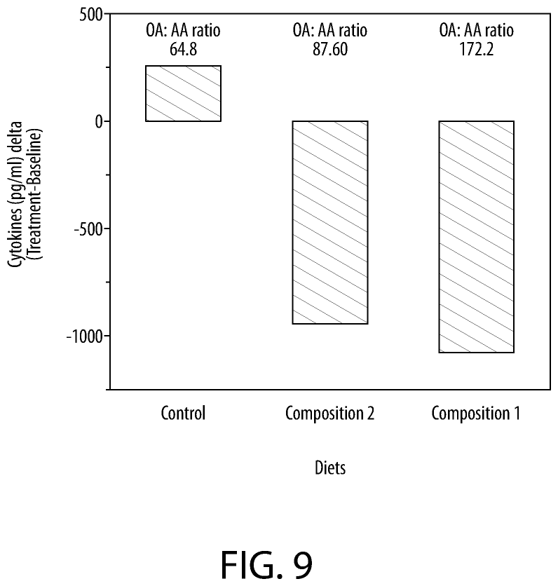

FIG. 9 shows cytokine levels from the serum of dogs fed either control or experimental compositions.

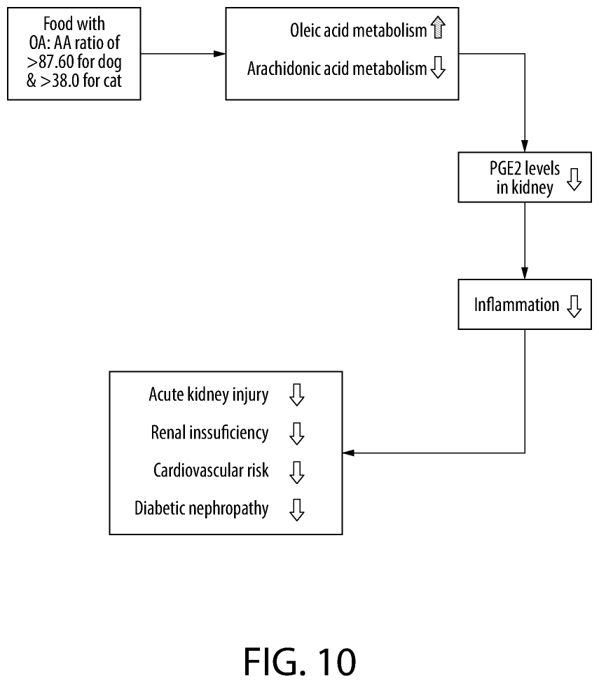

FIG. 10 shows a mechanism of how a diet with high oleic acid supplementation may reduce renal insufficiency and cardiovascular risk in companion animals.

### EXAMPLES

The examples and other implementations described herein are exemplary and not intended to be limiting in describing the full scope of compositions and methods of this disclosure. Equivalent changes, modifications and variations of specific implementations, materials, compositions and methods may be made within the scope of the present disclosure, with substantially similar results.

### Example 1

Twenty-four healthy dogs, aged 10.4 to 12.9 years old, weighing 6.9 to 13.3 kg, spayed or neutered, were fed a control diet comprising chicken, wheat, barley, sorghum, corn, corn gluten meal, chicken meal, pork fat, beet pulp, soybean oil, vitamins and minerals in a pre-feed phase for 4 weeks and then divided into one of two groups. For phase 1, Group 1 was fed a Control diet while group 2 was fed a test diet (Composition 1) for 8 weeks. (See Table 1 for detailed compositions). Next, a washout period was performed by feeding all dogs the maintenance diet again for 4 weeks. Then, for phase 2, group 1 was fed the test diet and group 2 was fed the control diet for 8 weeks. Blood/serum samples were collected at the end of each step (e.g. pre-feed, phase 1, washout, and phase 2) and stored at −80° C. until further analysis.

TABLE 1
Dog Food Compositions

| Ingredient | Control | Composition 1 | Composition 2 |
|---|---|---|---|
| Ash | 4.44 | 4.47 | 5.85 |
| Fat | 18.88 | 19.05 | 13.01 |
| Fiber crude | 1.7 | 1.8 | 1.8 |
| Protein | 26.57 | 26.28 | 23.63 |
| Carbohydrates | 41.57 | 40.95 | 47.3 |
| Water | 7.17 | 7.21 | 8.41 |
| | Each composition contains: | | |
| Total dietary fiber | 8 | 8.2 | 6.8 |
| Fiber neutral detergent | 8.3 | 8.8 | 7.1 |
| Arachidonic acid | 0.05 | 0.05 | 0.05 |
| Oleic Acid | 3.24 | 8.61 | 4.38 |
| Oleic Acid:Arachidonic | 64.8 | 172.2 | 87.6 |
| Acid Ratio | | | |
| Omega 3 | 0.63 | 0.67 | 0.34 |
| Omega 6 | 4.25 | 4.87 | 2.84 |

A non-targeted metabolomics analysis was performed on the frozen serum samples collected from each dog. Briefly, serum samples were partitioned with methanol and resulting extract was divided into five aliquots to analyze on four different platforms as established by Metabolon Inc., Morrisville, NC. For serum metabolite and cytokine analysis, delta (treatment—baseline) values were calculated. These values were determined by creating a variable which was the sum of the mean values for specific metabolites (as listed in FIG. 6 and FIG. 8) at specific time points. For example, sample collected from a specific animal at the end of treatment were subtracted by the sample collected from the same animal at the end of pre-fed (baseline). Statistical analysis was performed by using JMP Pro v14.0 (SAS, Cary, NC).

FIG. 1 shows a comparison of the conjugated metabolite results. “S” indicates a significance (P<0.05) between the diet comparison by matched pairs t-test. “NS” indicates no significance in the diet comparison by matched pairs t-test.

The different ratios of oleic acid to arachidonic acid (“OA:AA”) led to significant differences across the class of lipids, which included oleic acid (“OA”) and arachidonic acid (“AA”) metabolites. These metabolites, or biomarkers, show a decrease in inflammatory signal. Inflammation is known as an essential component of the immune system as it responds to infection or injury. However, the inflammatory response is typically meant to be transient and when the circumstances result in chronic inflammation it is a biological excess which is an important factor in the etiology of a range of common chronic diseases. Compositions of the invention resulted in a shift in the fatty acid moieties associated with a reduction in inflammation. For example, Composition 1, which had an OA:AA ratio of 172.2, showed a significant increase of serum OA conjugated metabolites compared with AA conjugated metabolites (see FIGS. 1, 5 & 6). Conversely, the Control diet, which had an OA:AA ratio of 64.8, showed significant increase of AA conjugated metabolites compared with OA conjugated metabolites (see FIGS. 1, 5 & 6). However, Composition 2, which has OA:AA ratio of 87.60, showed no significant differences between OA and AA conjugated metabolites (see FIGS. 1, 5 & 6). These results suggest that an OA:AA ratio greater than 87.60 decreases serum AA conjugated metabolites and ratio less than 87.60 increases serum AA conjugated metabolites.

### Example 2

Twelve healthy dogs, aged 1.2 to 8.5 years old, weighing 9.1 to 13.6 kg, spayed or neutered, were fed a control diet (same as in Example 1) in a pre-feed phase for 4 weeks followed by a treatment phase where the dogs were fed Composition 2 (See Table 1 for detailed compositions) for 4 weeks. Blood/serum samples were collected at the end of the pre-feed and treatment phases and stored at −80° C. until further analysis.

A non-targeted metabolomics analysis was performed on the frozen serum samples collected from each dog. Briefly, serum samples were partitioned with methanol and resulting extract was divided into five aliquots to analyze on four different platforms as established by Metabolon Inc., Morrisville, NC. For serum metabolite and cytokine analysis, delta (treatment—baseline) values were calculated. For example, sample collected from a specific dog or cat at the end of treatment were subtracted by the sample collected from the same dog or cat at the end of pre-fed (baseline). Statistical analysis was performed by using JMP Pro v14.0 (SAS, Cary, NC).

The results show that Composition 2 and Composition 1 significantly decreases plasma interleukin 8 (IL-8) expression levels compared with the Control diet (FIG. 9). Increased plasma IL-8 has been shown to potentially be involved with the pathogenesis of acute kidney injury (Liangos et al., Nephron Clin Pract., 2009, 113:c148-C154) and in the establishment and preservation of the inflammatory micro-environment of the insulted vascular wall (Apostolakis S. et al., Cardiovasc Res., 2009, 84(3):353-60). Therefore, these results suggest that the OA:AA ratio of 87.60:1 or greater has an anti-inflammatory effect.

### Example 3

Thirty healthy cats, aged 2.1 to 8.9 years old, weighing 3.5 to 7.5 kg, spayed or neutered, underwent a prefeed phase where each was fed a control diet comprising chicken, wheat, corn gluten meal, pork fat, chicken meal, beet pulp, rice, soybean oil, vitamins and minerals for 4 weeks and then divided into 6 groups. The treatment phase consisted of feeding to each group one of three treatment diets (Composition 3, Composition 4, or Composition 5) in a different order based on treatment groups (See Table 2 for detailed compositions). This experiment is a Latin Square design which allows each cat to be fed all of the treatment foods, one during each period of the treatment phase. Since there are six groups within this study design, no bias based on food order existed. Each treatment diet was fed for 80 days and then changed to another treatment diet without a washout period. Blood/serum samples were collected at the end of the pre-feed and individual treatment diet timeframe (80 days) and stored at −80° C. until further analysis.

TABLE 2
Cat food compositions

| | Composition 3 | Composition 4 | Composition 5 |
|---|---|---|---|
| Ingredient | (′316) | (′318) | (′317) |
| Ash | 4.61 | 5.22 | 6.65 |
| Fat | 12.45 | 12.62 | 12.99 |
| Fiber crude | 1.6 | 1.6 | 1 |
| Protein | 25.84 | 32.07 | 50.67 |
| Carbohydrates | 46.9 | 39.9 | 21.2 |
| Final composition | 8.59 | 8.58 | 7.47 |
| Moisture Content | | | |
| | Each composition contains: | | |
| Total dietary fiber | 6.2 | 5.6 | 4.2 |
| Fiber neutral detergent | 6.1 | 5.1 | 3.5 |
| Arachidonic acid | 0.1 | 0.11 | 0.18 |
| Oleic Acid | 4.35 | 4.18 | 4.04 |
| Oleic:Arachidonic | 43.5 | 38.0 | 22.4 |
| ratio | | | |
| Omega 3 | 0.18 | 0.2 | 0.24 |
| Omega 6 | 2.85 | 2.8 | 2.93 |

A non-targeted metabolomics analysis was performed on the frozen serum samples collected from each cat. Briefly, serum samples were partitioned with methanol and resulting extract was divided into five aliquots to analyze on four different platforms as established by Metabolon Inc., Morrisville, NC. For example, sample collected from a specific animal at the end of treatment were subtracted by the sample collected from the same animal at the end of pre-fed (baseline). Statistical analysis was performed by using JMP Pro v14.0 (SAS, Cary, NC).

FIG. 2 shows a comparison of the conjugated metabolite results. “S” indicates a significance (P<0.05) between the diet comparison by matched pairs t-test. “NS” indicates no significance in the diet comparison by matched pairs t-test.

The results show that in cats, the different ratios of OA:AA led to significant differences across the class of lipids which contained either OA or AA. For example, the diet of Composition 3 has OA:AA ratio of 43.5 shows significant increase of serum OA conjugated metabolites compared with AA conjugated metabolites (see FIGS. 2, 7 & 8). Conversely, the diet Composition 5, which had an OA:AA ratio of 22.44, showed significant increase of AA conjugated metabolites compared with OA conjugated metabolites (see FIGS. 2, 7 & 8). However, Composition 4, which had an OA:AA ratio of 38.0, showed no significant differences between OA and AA conjugated metabolites (see FIGS. 2, 7 & 8). These results suggest that OA:AA ratio greater than 38.0 decreases serum AA conjugated metabolites and ratio lesser than 38.0 increases serum AA conjugated metabolites.

In summary, these results suggest that OA:AA ratio impacts host fatty acid metabolism and higher ratio (greater than 87.60 for dogs; greater than 38.0 for cats) suppresses AA metabolism and enhance OA metabolism, which has potential in alleviating CvRD/CRS syndrome. The proposed mechanism of action depicts that increasing OA:AA ratio in diet reduces AA metabolism, impacts PGE2 levels and reduce inflammation to alleviate chronic kidney damage or acute kidney injury as well as attenuating cardiovascular-renal axis disorders in companion animals (See FIG. 10).

While the present invention has been described with reference to several embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention is to be determined from the claims appended hereto. Further, it will be apparent to those of skill in the art that numerous changes may be made in such details without departing from the spirit and the principles of the invention.

1. A pet food composition comprising:
oleic acid; and
arachidonic acid;
wherein the weight ratio of oleic acid to arachidonic acid is about 87.6 or greater.

2. The pet food composition according to claim 1, wherein the weight ratio of oleic acid to arachidonic acid is from about 87.6 to about 200:1.

3. The pet food composition according to claim 1, wherein the weight ratio of oleic acid to arachidonic acid is from about 100:1 to about 200:1.

4. The pet food composition according to claim 1, wherein the weight ratio of oleic acid to arachidonic acid is from about 160:1 to about 190:1.

5. The pet food composition according to claim 1, wherein the weight ratio of oleic acid to arachidonic acid is about 172:1.

6. The pet food composition according to claim 1, wherein the oleic acid is present in an amount of about 4 to about 12 weight %, based on the dry weight of the pet food composition.

7. The pet food composition according to claim 1, wherein the arachidonic acid is present in an amount of about 0.02 to about 1 weight %, based on the dry weight of the pet food composition.

8. The pet food composition according to claim 1, further comprising one or more omega-3 fatty acids, wherein the omega-3 fatty acids are present in an amount of about 0.1 to about 1 weight %, based on the dry weight of the pet food composition.

9. (canceled)

10. The pet food composition according to claim 8, further comprising one or more omega-6 fatty acids, wherein the omega-6 fatty acids are present in an amount of about 1 to about weight %, based on the dry weight of the pet food composition.

11. (canceled)

12. The pet food composition according to claim 10, wherein the weight ratio of omega-3 fatty acid to omega-6 fatty acid is from about 1:5 to about 1:10.

13. A method for increasing the oleic acid conjugated metabolites and decreasing the arachidonic acid conjugated metabolites in a dog, reducing serum interleukin-8 (IL-8) in a dog, or reducing prostaglandin E2 (PGE2) levels in the kidney tissue of a dog, the method comprising feeding the dog the pet food composition of claim 1.

14.-15. (canceled)

16. A pet food composition comprising:
oleic acid; and
arachidonic acid;
wherein the weight ratio of oleic acid to arachidonic acid is about 38.0 or greater.

17. The pet food composition according to claim 16, wherein the weight ratio of oleic acid to arachidonic acid is from about 38:1 to about 60:1.

18. The pet food composition according to claim 16, wherein the weight ratio of oleic acid to arachidonic acid is about 43:1.

19. The pet food composition according to claim 16, wherein the oleic acid is present in an amount of about 2 to about 8 weight %, based on the dry weight of the pet food composition.

20. The pet food composition according to claim 16, wherein the arachidonic acid is present in an amount of about 0.05 to about 2 weight %, based on the dry weight of the pet food composition.

21. The pet food composition according to claim 16, further comprising one or more omega-3 fatty acids, wherein the omega-3 fatty acids are present in an amount of about 0.05 to about 1 weight %, based on the dry weight of the pet food composition.

22. (canceled)

23. The pet food composition according to claim 21, further comprising one or more omega-6 fatty acids, wherein the omega-6 fatty acids are present in an amount of about 1 to about 10 weight %, based on the dry weight of the pet food composition.

24. (canceled)

25. The pet food composition according to claim 23, wherein the weight ratio of omega-3 fatty acids to omega-6 fatty acids is from about 1:10 to about 1:20.

26. A method for increasing the oleic acid conjugated metabolites and decreasing the arachidonic acid conjugated metabolites in a cat or reducing prostaglandin E2 (PGE2) levels in the kidney tissue of a cat, comprising feeding the cat the pet food composition of claim 16.

27. (canceled)
